(19) United States
(12) Patent Application Publication
(10) Pub. No.: US 2009/0168946 A1
(43) Pub. Date: Jul. 2, 2009

(54) Thermal limit analysis with hot-channel model for boiling water reactors

(76) Inventor: YANG-KAI CHIU, Taoyuan County (TW)

Correspondence Address: MICHAEL LIN, 5F 79 Roosevelt Rd. Sec. 2, TAIPEI, 106, TW

(21) Appl. No.: 11/968,196

(22) Filed: Jan. 2, 2008

(51) Int. Cl. G21C 17/108

(52) U.S. Cl. 376/254

(57) ABSTRACT

An analytical method for the initial flux and transient hot water flow parameters for a boiling water reactor with single fuel bundle. Firstly, the method is to calculate intial flux and transient hot water flow parameter based on single fuel bundle. Then, it uses supplier provided CPR (Critical Power Ratio) correlation to calculate transient CPR and calculate the whole reactor core for hot water parameters as boundary condition. Iteration is used to figure out DCPR (Delta Critical Power Ratio). The obtained limit transient is selected as the maximum from DCPR. The maximum transient DCPR combines Safety Limit Minimum Critical Power Ratio (SLMCPR) and safety margin to figure out the OLMCPR (Operating Limit Minimum Critical Power Ratio). Both the plant layout and operational thermal limit are based on OLMCPR to assure the safety of reactor core.

### BACKGROUND OF THE INVENTION

1. Field of the Invention

The invention is related to a transient event analytical method for calculation of safe thermal limit for a boiling water reactor. Especially, it refers to a simulation method for single fuel bundle. The objectives of calculation are two: the first is to calibrate and calculate the highest inlet flux for fuel bundle for transient initial (at time zero) reactor core power and the second is to combine transient thermal flow parameters for Retran power plant simulation system and hot channel initial flux calculation for DCPR (Delta Critical Power Ratio) iteration. CPR (Critical Power Ratio) is the ratio of predicted assembly critical power (dry out occurred) over actual assembly power, represented by CPR=Predicted Critical Power/Actual Bundle Power.

In INER's methodology, DCPR calculation for a transient use the hydraulic parameter (power, inlet enthalpy and inlet & outlet pressure). For the first calculation, the transient minimum CPR (MCPR) will be higher than 1.0. Then we proceed with iteration process increases assembly power to lower transient minimum CPR until minimum CPR equal 1.0. The initial CPR minus 1.0 (minimum CPR) during latest transient calculation is the DCPR of the transient.

2. Description of the Prior Art

Before replacement of nuclear fuel after each cycle of operation in a nuclear power plant, it is necessary to complete the safety calculation for the next operation cycle. The calculation includes thermal limit and pressure limit. Because in a boiling water reactor core, there are usually hundreds of fuel bundles with independent channels, the analysis is to seek the hottest fuel bundle and calculate its transient CPR variation. There are two important steps of calculation in the process: the first is to calculate the transient initial flux for hot channel; although the fuel top and inlet are connected and have the same pressure drop, each channel has different flux due to different thermal power for every fuel bundle; it is necessary to have a mode to determine the initial flux for hot channel; the second is to calculate the flux in a transient process; the original calculation is based on reactor core flux variation from a system mode with proportionality between assumption and hot channel flux and use the boundary condition for initial flux in hot channel for iteration for MCPR variation.

For the first part, in the early time the calculation of fuel channel flux in a reactor core usually is determined by reactor core sub-channel program like ISCORE (GE), XCOBRA (AREVA), COBRA-III C (Taipower/Institute of Nuclear Energy Research) or hot water mode from the core neutron cross-section calculation program SIMULATE (Spain Iberinco). Each channel flux is determined by inlet connected and outlet connected parallel independent multiple channel mode. The original methodology by Taipower and Institute of Nuclear Energy Research was MIT-developed COBRA-III C program modified with bypass mode and established with fuel independent channel in ¼ core to calculate the steady state initial flux for each channel. This was also a parallel independent and multiple channel modes. But after fuel suppliers put some short fuel rods in the new fuel bundle and change the flow channel area, COBRA-III C program cannot simulate this phenomenon.

For the calculation of water flow parameters for transient heat in the second part, every BWR fuel supplier and every research organization use system simulation program to simulate the overall transient response of a power plant and hot water flow parameter variation at each node, like GE uses ODYN, AREVA uses COTRANSA2, Iberinco uses RETRAN, Taipower/Institute of Nuclear Energy Research use RETRAN program of current version RETRAN-3D MOD4.1. The transient event for reactor core is to use single fuel bundle mode to adopt the mode calculated variation for transient hot water flow parameters at inlet and outlet nodes. The parameters adopted by each company are a little different. They include total power variation for transient fuel bundle, transient axial power variation, and inlet cooling water enthalpy, outlet pressure and transient inlet cooling water flow variation. The parameters are provided according to the methodology adopted. For example, AREVA uses core flow variation by system transient program and hot channel initial flux to determine flux variation in hot channel. The COBRA hot channel model used by Taipower/Institute of Nuclear Energy Research in the past also adopted the same method. Iberinco uses pressures at core inlet and bypass channel as boundary condition and determines the variation in transient flux in hot channel with hot channel power.

In the first part to determine the hot channel flux, the whole or ¼ reactor core mode needs to include bypass channel, which flux ratio depends on inlet and outlet pressure, core bottom plate, fuel bottom plate gap and gap between the fuel bottom plate and fuel bundle and flow resistance coefficient that are obtained from fuel suppliers and converted to input format for analytical mode; SIMULATE program has different flow resistance coefficient mode than that provided by common fuel suppliers, so when it is in use, an additional numerical approximation is needed.

In the second part for hot channel transient analysis, if the flux variation of the system transient mode is used, the implied assumption is the ratio of hot channel flux to the average flux is constant in the transient process. If the inlet outlet pressure for fuel bundle is used as boundary condition, the transient hot channel flux is more consistent with the actual condition.

### SUMMARY OF THE INVENTION

The main objective for the invention is to provide an analytical method for the hot channel initial flux and transient thermal flow parameters for a boiling water reactor and reduce the calculation time. After verification, it is proved with validity.

To achieve the above objective, the invention that provides an analytical method for the hot channel initial flux and transient thermal flow parameters for a boiling water reactor first establishes the hot channel model for a single fuel bundle in RETRAN program for nuclear power plant safety analysis. The axial pressure distribution from the analytical mode by fuel suppliers is used to calibrate each flow resistance coefficient (Form Loss Coefficient). Depending on different operation conditions, two modes are established, 100% power/105% flux and 40% power/50% flux. Because the initial pressure is quite different between rated condition and partial power condition, so INER's methodology chosed 40% power/50% flux condition to calculate partial power condition. Transient mode is determined by selecting approximated operation condition. The mode is then used to determine the initial flux for reactor core hot channel fuel bundle at different power and following transient hot water flow parameters. For the calculation for transient hot water flow parameters, the previous hot channel model established on corresponding axial pressure distribution is used with another Fortran program to handle the calculation for the transient thermal flow parameters by RETRAN system transient mode. Also through iteration for power increase to determine transient MCPR, the transient minimum MCPR converges to 1.0. Finally, the maximum DCPR value of all transient values is recorded. The sum of this maximum DCPR and SLMCPR is OLMCPR, which is the basis for power plant layout design and operation thermal limit.

The unique feature for the invention is to use single fuel bundle mode to calculate transient hot water flow parameters.

### BRIEF DESCRIPTION OF THE DRAWINGS

FIG. 1 is the basic process flow diagram for the invention.

FIG. 2 is an illustration for the methodology for the transient analysis for the invention.

FIG. 3 is the process flow diagram for the methodology for the transient analysis for the invention.

FIG. 4 is the node diagram for the RETRAN single fuel bundle.

FIG. 5 is an illustration for inlet flux vs. fuel bundle power in the invention.

FIG. 6 is the node diagram for transient analysis mode for the RETRAN system in 2^{nd} nuclear power plant in the invention.

FIG. 7 is the fuel bundle power vs. inlet flux for No. 2 reactor at cycle 18 with 100% power/105% flux in 2^{nd} nuclear power plant in the invention.

FIG. 8 is the fuel bundle power vs. inlet flux for No. 2 reactor at cycle 18 with 40% power/50% flux in 2^{nd} nuclear power plant in the invention.

### DETAILED DESCRIPTION OF THE PREFERRED EMBODIMENT

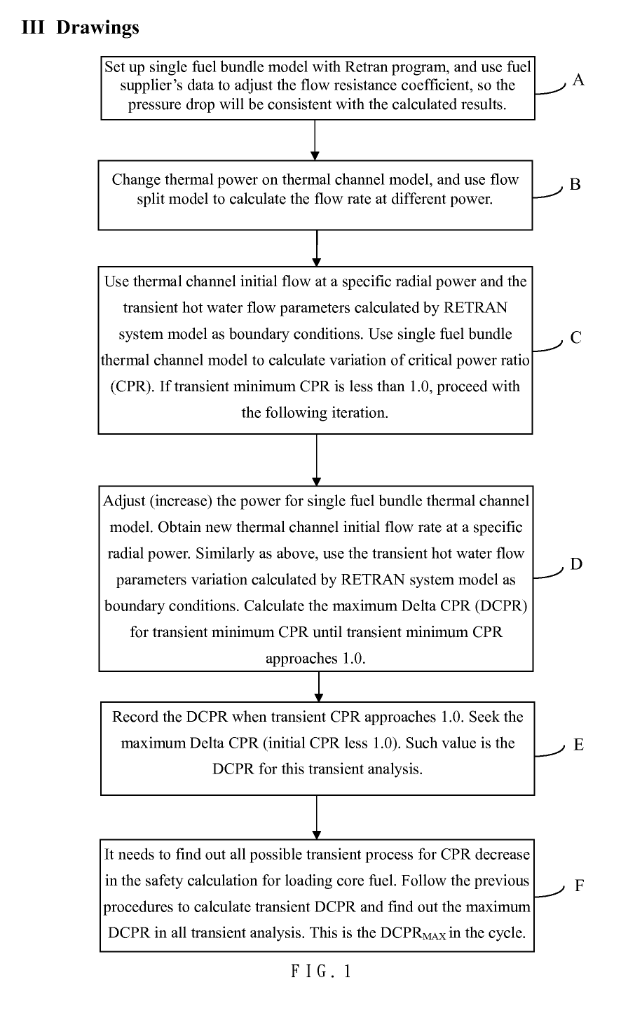

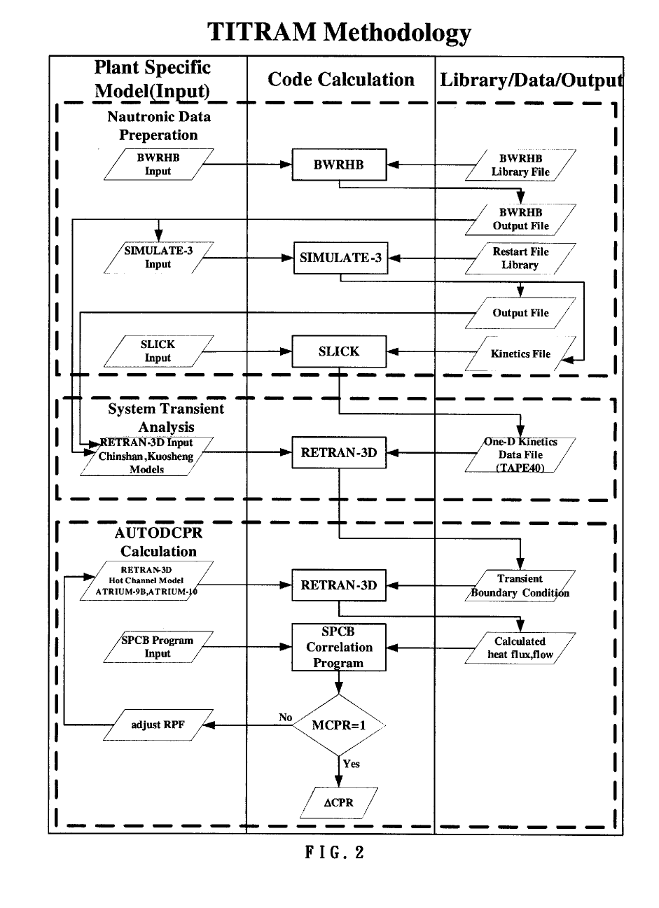

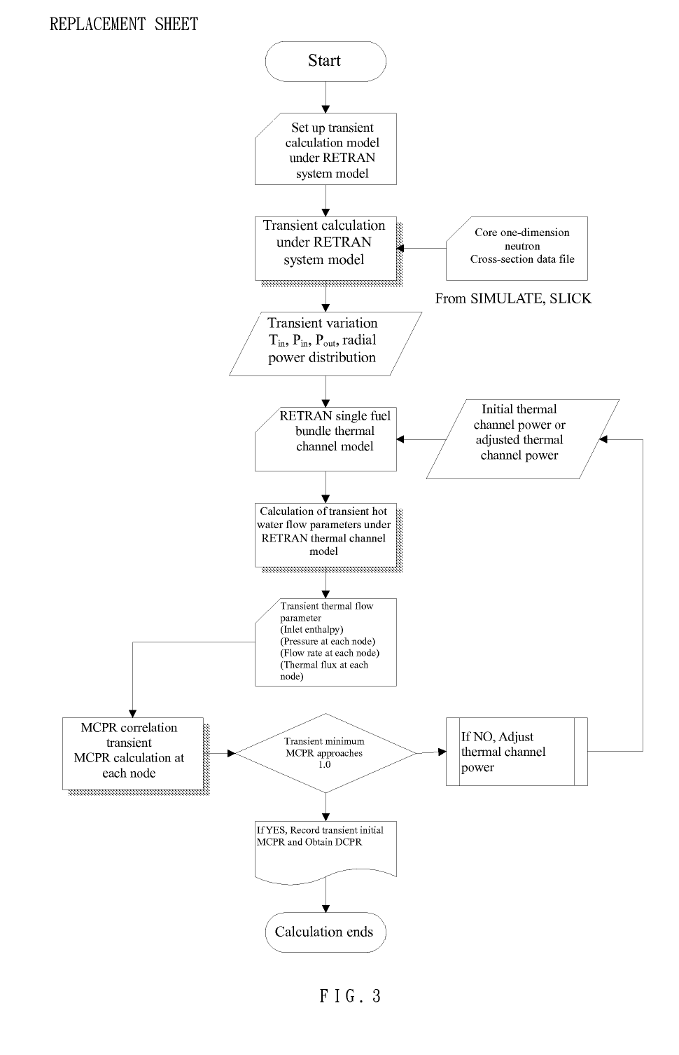

Please refer to FIG. 1 for the basic process flow diagram for the invention. As shown in the figure, the invention is an analytical method for the thermal limit in a transient event regarding fuel refill in a boiling water reactor. To prevent the transient event during operation of a boiling water reactor to cause fuel to reach thermal limit and hazard, it is necessary to analyze the fuel transient event prior to operation. The transient heat limit analysis needs to find out the fuel transient event for transition boiling to occur and proceeds with analysis on the above situations. For the selection method for transient event, the Standard Review Plan (NUREG-0800) has already classified the possible transient events. After assessment by the reactor and fuel designing companies in the Final Safety Analysis Report (FSAR), the following calculation of thermal limit in the fuel refill safety analysis only selects the three transient events that reduce MCPR most in the process. The analytical method in the present invention is aiming to establish a hot channel model for pre-selected single fuel bundle. It also uses automatic program to adopt the boundary conditions for hot water flow parameters calculated by nuclear power plant system transient calculation mode, and calculates transient DCPR, and reduce calculation time and human errors. The calculation process for transient DCPR is shown in FIG. 2, including calculation for core center and interface, and hot channel iteration. FIG. 3 is the detailed process for the automatic program AUTODCPR to calculate transient DCPR. The main step in the invention is the AUTODCPR hot channel model in FIG. 3. The procedure to set up hot channel for a single fuel bundle includes calibration and transient calculation steps, as shown in FIG. 1.

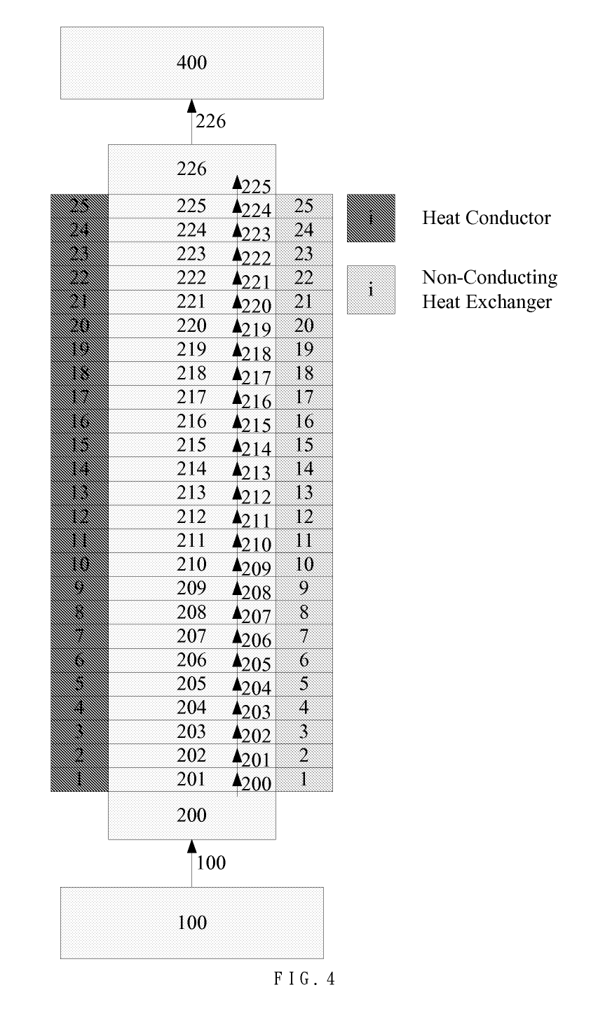

Step a: Set up single fuel bundle mode with Retran program as in FIG. 4, and use fuel supplier's data to adjust the flow resistance coefficient, so the pressure drop will be consistent with the calculated results. Since the pressure drop coefficient from the fuel suppliers has been verified by experimental data, but we do not obtain experimental data when setting up the single fuel bundle mode, the pressure drop is a function of Reynold number, and expressed as follows:

k=A+B×R e^{-C} (1)

In which A, B and C are constant. In this stage, RETRAN program cannot note Reynold numbers to figure out pressure drop coefficient. So in this hot channel model, the simulated value of pressure drop same to supplier's calculated value is substituted.

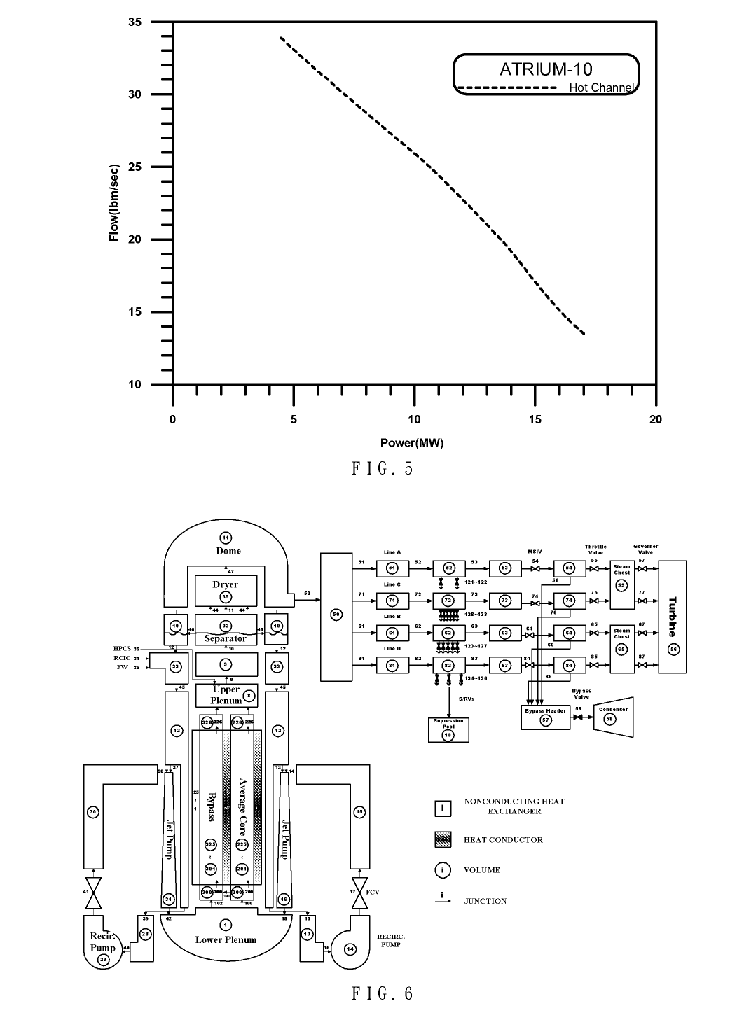

Step b: To satisfy different operation condition, set up two modes in 100% power/105% flux and 40% power/50% flux. Under the fixed pressure drop, increasing fuel bundle power will increase bi-phase flow zone. Under the same inlet and outlet pressure drop, increasing power will decrease hot channel flux, as shown in FIG. 5. The relationship between the power and flux will be used in AUTODCPR iteration in FIG. 3.

Step c: Set up power plant system mode in RETRAN program and conduct transient simulation. Take the node diagram for 2^{nd} Nuclear Power Plant in FIG. 6 as example, to calculate the response of system loop to transient event. Use RETRAN system mode to enter assumed transient conditions for calculation and record key transient parameters for reactor core, like inlet temperature, inlet pressure, outlet pressure and axial power as boundary conditions for hot channel model for a single fuel bundle. Also calculate critical power ratio CPR at each transient time point.

Step d: If minimum transient CPR has not reached 1.0, the following criteria, 10⁻⁴, is used to determine convergence.

|Min [CPR(t)]−1.0|≦1.0×1.0×10⁻⁴ (2)

If there is no convergence, adjust hot channel model power until the minimum CPR reached 1.0. The adjustment is as follows:

RPF_{new}=RPF_{old}×{1+0.8×(Min [CPR(t)]−1)} (3)

Step e: The maximum variation DCPR is the transient initial (time at 0 second) CPR less 1.0.

Step f: Take 2^{nd} nuclear power plant (Kuosheng Plant, KS) as example. The table 1 shows examples of transient calculation for each cycle, including different operation power, flux and fuel consumption. Find out the maximum transient DCPR at each operation condition to combine safety limit minimum critical power ratio SLMCPR and safety margin to calculate operation limit OLMCPR. Both power plant layout design and operational thermal limit are based on OLMCPR. In this way, it will find out sufficient safety margin to assure reactor core safety.

TABLE 1

| KS1 | Transient | KS2 | Transient |
|---|---|---|---|
| C16 | FWCF100100 | C16 | FWCF100105 |
| | FWCF100105 | | TTNB4050 |
| | LRNB100100 | | TTNB40105 |
| | PRDSF100100 | | TTNB100105 |
| | PRDSF100105 | | |
| | TTNB2550 | | |
| | TTNB2570 | | |
| | TTNB4050 | | |
| | TTNB10075 | | |
| | TTNB40105 | | |
| | TTNB70105 | | |
| | TTNB100100 | | |
| | TTNB100105 | | |
| | TTWO40105 | | |
| C17 | FWCF100105 | C17 | FWCF40105 |
| | TTNB4050 | | FWCF70105 |
| | TTNB4O105 | | FWCF100105 |
| | TTNB100105 | | TTNB4075 |
| | | | TTNB70105 |
| | | | TTNB100105 |
| | | | TTWO2550 |
| | | | TTWO2560 |
| | | | TTWO4050 |
| | | | TTWO40105 |
| C18 | FWCF40105 | C18 | FWCF40105 |
| | FWCF70105 | | FWCF70105 |
| | FWCF100105 | | FWCF100105_X12903.8 |
| | TTNB4075 | | TTNB40105_X12903.8 |
| | TTNB70105 | | TTNB70105_X12903.8 |
| | TTNB100105 | | TTNB100105 |
| | TTWO2550 | | TTWO2550 |
| | TTWO2560 | | TTWO2550_X5200.0 |
| | TTWO2570 | | TTWO2570 |
| | TTWO4050 | | TTWO2570_X0.0 |
| | TTWO40105 | | TTWO4050 |
| | | | TTWO40105 |
| C19 | FWCF40105_X13375.6 | C19 | FWCF40105_X14008.1 |
| | FWCF70105_X13375.6 | | FWCF70105_X14008.1 |
| | FWCF100105_X13375.6 | | FWCF100105_X14008.1 |
| | TTNB4075_X13375.6 | | LRNB4075_X14008.1 |
| | TTNB40105_X13375.6 | | LRNB70105_X14008.1 |
| | TTNB70105_X13375.6 | | LRNB100105_X14008.1 |
| | TTNB100105_X13375.6 | | LRWO2550_X0.0 |
| | TTWO2550_X0.0 | | LRWO2560_X6600.0 |
| | TTWO2560_X0.0 | | LRWO4050_X0.0 |
| | TTWO4050_X1300.0 | | LRWO40105_X0.0 |
| | TTWO40105_X0.0 | | TTNB4075_X14008.1 |
| | | | TTNB70105_X14008.1 |
| | | | TTNB100105_X14008.1 |
| | | | TTWO2550_X0.0 |
| | | | TTWO2560_X6600.0 |
| | | | TTWO4050_X0.0 |
| | | | TTWO40105_X0.0 |

Referring to the following embodiments for detailed implementation conditions:

### Embodiment 1

The analytical method in the invention is applied to transient DCPR calculation for a reactor core that has 100% power/105% flux, feedwater control failure and no bypass.

Please refer to FIGS. 1, 2 and 3 for the basic process flow diagram for transient DCPR, the establishment of RETRAN hot channel model by Step a as explained in FIG. 4, the effect of hot channel radial power ratio variation on fuel inlet flux for the RETRAN hot channel model for a reactor core under 100% power/105% flux as shown in FIG. 5 and set by Step b in Embodiment 1, and node diagram for 2^{nd} nuclear power plant in Step c in Embodiment 1. For the process flow diagram for the Step d in Embodiment 1, please refer to FIG. 3.

As shown in the figure: the embodiment conducted event analysis for No. 2 reactor in 2^{nd} Nuclear Power Plant with feedwater control failure and no bypass. The reactor core operation condition is 100% power/105% flux. The reactor core for 2^{nd} Nuclear Power Plant has 624 fuel bundles. In this cycle, all the reactor fuel is ATRIUM-10 from AREVA Company. The DCPR analytical method for the invention is only on the hottest channel in reactor core and consists at least the following steps:

Step a: Use RETRAN program to set up single fuel bundle and system analytical mode, including the following steps:

11. Collect fuel geometric data including flow area, heat peripheral, wetted peripheral, part length at each axial node, rod number, and grid location in axial direction of fuel assembly to establish the single fuel bundle mode as shown in FIG. 4. The mode divides the fuel channel into 25 nodes. Above and below the fuel there adds one node for each to correspond to system simulation mode. Nodes 100 and 400 are time-dependent control variables. There is space for accepting system-calculated variables. 25 fuel nodes have their corresponding thermal conductors to input fuel power and power distribution. Between nodes, there is connection and simulation lattice.

12. Use plant geometry data and control logics to set up the basic RETRAN power plant system mode. As in FIG. 6 there are 412 nodes in the basic mode to simulate hot water flow in a power plant. They have been calibrated by starting up the plant operation.

From Step 11 and 12, simulation can be conducted for transient hot water parameters for the single fuel bundle in the reactor core.

Step b: Transient simulation follows standard inspection process NRUG-0800 and conditions based on supplier's conservative assumption are entered into the basic mode in RETRAN system. The assumptions for feedwater failure and no bypass are as follows:

Neutron analysis and calculation uses Licensing Base to consume until the End of Cycle (EOC). For power distribution, peak power is at the top of reactor core.

The demand signal for feedwater controller increases within 0.1 second to 1305 of the maximum demand.

During transient period, feedwater temperature is constant.

High water level signal makes steam control valve and steam stop valve immediately shut off. There is a delay of 0.1 second. It simultaneously causes no delay for feedwater pump shut-off. For reactor shut-off, there is 0.07 second of delay for protection.

Stop valve is shut linearly. Shutting time from full openness to full closure is 0.1 second. Control valve has 0.15 second as shutting time.

When stop valve opens 90%, recirculation pump starts with 0.14 second delay.

Control rod system has 0.14 second delay from emergency stop signal to actual start.

Control rod is inserted at constant insertion speed. It takes 2.147 seconds for complete insertion (including 0.1 second of delay).

Steam bypass valve does not open.

The delay for opening steam relief valve is 0.4 second. It is 0.15 second from full openness to full closure.

Signal reset time for steam relief valve is 0.4 second. It is 0.15 second from full openness to full closure.

Step c: Use single fuel bundle RETRAN mode to establish the relationship between fuel bundle power ratio and the inlet flux under such analytical condition. The detailed procedure at least includes:

21. Use single fuel bundle RETRAN mode as basis. Under the operation condition 100% power/105% flux, use supplier's pressure distribution data to adjust RETRAN single fuel bundle mode, so the two have the consistent pressure at nodes and fixed flow resistance coefficient.

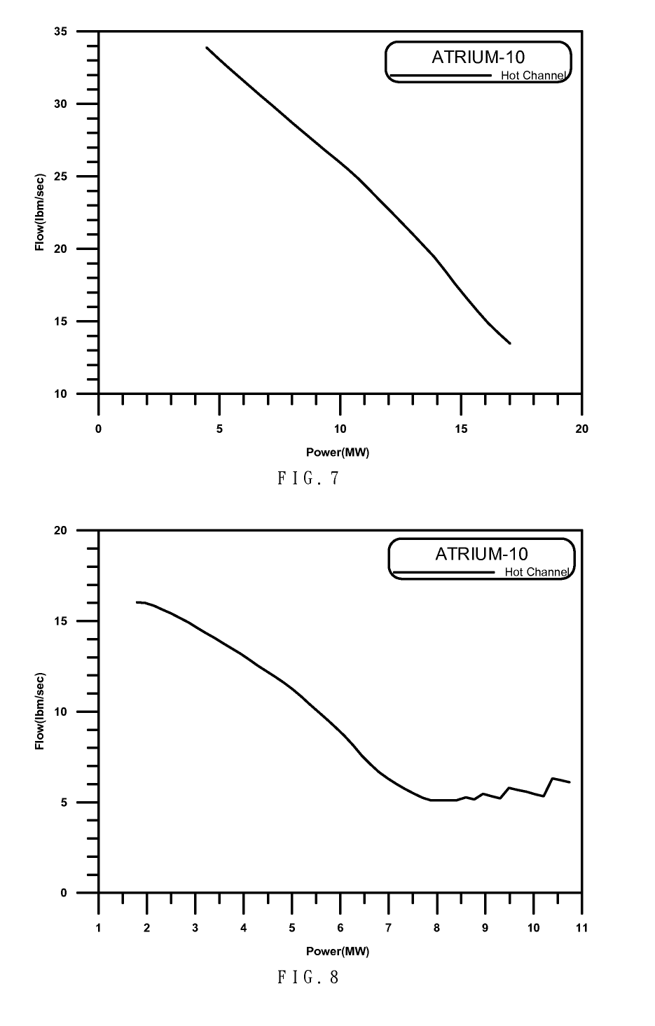

22. Use the single fuel bundle mode after adjustment of flow resistance coefficient as basis, change the flux corresponding to the recorded fuel bundle power, as shown in FIG. 7.

Step d: Use Fortran language to write interface and data processing program AutoDCPR. The flow diagram for programming is shown in FIG. 3. AutoDCPR program will automatically execute the following steps:

31. Read transient hot water parameters from RETRAN system mode, such as inlet temperature, inlet pressure, outlet pressure and axial power as boundary conditions for single fuel bundle hot channel model.

32. Calculate transient MCPR for a single channel RETRAN mode.

33. Follow the method described in Step d to adjust the power for single channel RETRAN mode.

34. Re-calculate transient MCPR for a single channel RETRAN mode. Repeat until the minimum transient MCPR equals 1.0.

35. Record the transient initial MCPR. After subtracting the minimum transient MCPR (1.0), it becomes the DCPR for the present transient event.

Through the above method to search for possible transient events, fuel operation needs to have the minimum MCPR value, i.e. the plant operated at 100% power/105% flux maintains reactor core MCPR higher than DCPR+1.0 to assure feedwater failure and no bypass. It is impossible for MCPR lower than 1.0 and for transient boiling situation, which would increase fuel protector temperature and break it, and then make radioactive fission products released into cooling water system.

The DCPR for the fuel bundle ATRIUM-10 in the embodiment is calculated to be 0.14094.

### Embodiment 2

The analytical method in the invention is applied to transient DCPR calculation for a reactor core that has 40% power/50% flux, feedwater control failure and no bypass.

The flow process and Step a are the same as those in Embodiment 1.

Step b: Transient simulation follows standard inspection process NRUG-0800 and conditions based on supplier's conservative assumption are entered into the basic mode in RETRAN system. The assumptions for feedwater failure and no bypass are as follows:

Neutron analysis and calculation uses Licensing Base to consume until the End of Cycle (EOC). For power distribution, peak power is at the top of reactor core.

Stop valve shuts off within 0.1 second.

During transient period, feedwater temperature is constant.

When the steam top tank pressure reaches 1095.7 psia, it takes 0.07 second of delay for reactor protection system to immediately shut down the reactor.

When neutron flux reaches 122%, it takes 0.11 second (0.07 second of delay for reactor protection system, 0.04 second of signal detection) of delay to immediately shut down the reactor.

Re-circulation pump fails to shut off.

Control rod system has 0.1 second delay from emergency stop signal to actual start.

Control rod is inserted at constant insertion speed. It takes 2.147 seconds for complete insertion (including 0.1 second of delay).

Steam bypass valve does not open.

The delay for opening steam relief valve is 0.4 second. It is 0.15 second from full openness to full closure.

Signal reset time for steam relief valve is 0.4 second. It is 0.15 second from full openness to full closure.

Step c: Use single fuel bundle RETRAN mode to establish the relationship between fuel bundle power ratio and the inlet flux under such analytical condition. The detailed procedure at least includes:

41. Use single fuel bundle RETRAN mode as basis. Under the operation condition 40% power/50% flux, use supplier's pressure distribution data to adjust RETRAN single fuel bundle mode, so the two have the consistent pressure at nodes and fixed flow resistance coefficient.

42. Use the single fuel bundle mode after adjustment of flow resistance coefficient as basis, change the flux corresponding to the recorded fuel bundle power, as shown in FIG. 8.

Step d: Use Fortran language to write interface and data processing program AutoDCPR. The flow diagram for programming is shown in FIG. 3. AutoDCPR program will automatically execute the following steps:

51. Read transient hot water parameters from RETRAN system mode, such as inlet temperature, inlet pressure, outlet pressure and axial power as boundary conditions for single fuel bundle hot channel model.

52. Calculate transient MCPR for a single channel RETRAN mode.

53. Follow the method described in Step d to adjust the power for single channel RETRAN mode.

54. Re-calculate transient MCPR for a single channel RETRAN mode. Repeat until the minimum transient MCPR equals 1.

55. Record the transient initial MCPR. After subtracting the minimum transient MCPR (1.0), it becomes the DCPR for the present transient event.

Through the above method to search for possible transient events, fuel operation needs the minimum MCPR value, i.e. the plant operated at 40% power/50% flux maintains reactor core MCPR higher than DCPR+1.0 to assure feedwater failure and no bypass. It is impossible for MCPR lower than 1.0 and for transient boiling situation, which would increase fuel protector temperature and break it, and then make radioactive fission products released into cooling water system.

The DCPR for the fuel bundle ATRIUM-10 in the embodiment is calculated to be 0.44971.

In summary, the analytical method in the invention for transient event in a boiling water reactor can effectively improve the drawbacks with the original method. This will include:

1. Use RETRAN to establish a single fuel hot channel model to calculate fuel initial flux and save calculation time as well as accurately predict transient initial hot channel flux.

2. It can accurately and conservatively calculate transient DCPR and determine operation limit value. Further it uses automatic program to conduct transient safety analysis to assure the safety for reactor core. Because the invention is progressive, practical and satisfactory to user's needs, it meets patent requirements and the application is thus submitted. The above mentioned is only preferred embodiment for the invention, but not to limit the scope of the invention. Those equivalent modifications to the description in the invention shall all be covered by the scope of the invention.

What is claimed is:

1. A transient analytical method for the thermal limit in a boiling water reactor comprising the following steps:
a. Collecting accurate geometric data including flow section area, heat peripheral, wetted peripheral, part length at each axial node, rod number and grid location in axial direction of fuel assembly;
b. Inputting the data collected in step a into a power plant simulation system to calculate minimum critical power ratio (MCPR), wherein the critical power ratio (CPR) is defined as:
CPR=Predicted Critical Power/Actual Bundle Power;
c. Introducing parameters including power, inlet enthalpy, inlet and outlet pressures in a way to minimize calculation value of CPR;
d. Adjusting flow resistance coefficient, changing fuel bundle power and recording flux at each power point in accordance with a pressure distribution data furnished by vendor in the power plant simulation system;;
e. Obtaining a transient delta critical power ratio (DCPR) value by equating initial MCPR value minus transient MCPR value; and
f. Shutting off core reactor of the power plant when MCPR value less than 1.

2. As described in claim 1 for a transient analytical method for thermal limit in a boiling water reactor, Step a refers to a single fuel bundle analytical mode.

3. As described in claim 1 for a transient analytical method for thermal limit in a boiling water reactor, it also includes the basic mode for thermal limit analysis.

4. (canceled)

5. As described in claim 1 for a transient analytical method for thermal limit in a boiling water reactor, it also contains another single fuel bundle mode to determine the inlet initial flux for fuel bundle at different power.

6. As described in claim 1 for a transient analytical method for thermal limit in a boiling water reactor, the transient DCPR calculation method includes the following steps:
a) Reading transient hot water parameters from power plant simulation system including feed water inlet temperature, inlet pressure, outlet pressure and axial power distribution as boundary conditions for single fuel bundle hot channel model;
b) Calculating transient MCPR for a single channel RETRAN mode;
c) Adjusting the power with the transient hot water parameters for single channel mode;
If transient minimum CPR value has not reached 1.0, use the following criteria 10⁻⁴ to determine convergence:

|Min [CPR(t)]−1.0|≦1.0×10⁻⁴
If no convergence, adjust the power for hot channel model until CPR minimum value reaches 1.0, the adjustment is as follows:
RPF_{new}=RPF_{old}×{1+0.8×(Min [CPR(t)]−1)}
d) Re-calculating transient MCPR for single channel RETRAN mode; Repeat step c) until transient minimum MCPR equals to 1.0;
e) Recording the transient initial MCPR, and using the transient initial MCPR to subtract transient minimum MCPR (1.0) to obtain the transient DCPR.
